(19) United States
(12) Patent Application Publication
(10) Pub. No.: US 2024/0263937 A1
(43) Pub. Date: Aug. 8, 2024

(54) MEASUREMENT HEAD

(71) Applicant: trinamiX GmbH, Ludwigshafen am Rhein (DE)

(72) Inventors: Celal Mohan OEGUEN, Ludwigshafen am Rhein (DE); Christopher HAHNE, Bern (CH); Robert SEND, Karlsruhe (DE); Ingmar BRUDER, Ludwigshafen am Rhein (DE)

(21) Appl. No.: 18/567,124

(22) PCT Filed: Jun. 30, 2022
(86) PCT No.: PCT/EP22/68057

§ 371 Date: Dec. 5, 2023

(30) Foreign Application Priority Data
Jul. 2, 2021 (EP) 21183542.6

(51) Int. Cl. G01B 11/02; G01B 11/22

(52) U.S. Cl. CPC G01B 11/026; G01B 11/22

(57) ABSTRACT

Described herein is a measurement head for determining a position of at least one object. The measurement head includes:
at least one transfer device; and
at least one bundle of optical fibers.

### FIELD OF THE INVENTION

The invention relates to a measurement head for determining a position of at least one object, a kit and various uses of the measurement head. The devices and uses according to the present invention specifically may be employed for example in various areas of daily life, gaming, traffic technology, production technology, security technology, photography such as digital photography or video photography for arts, documentation or technical purposes, medical technology or in the sciences. Further, the invention specifically may be used for scanning one or more objects and/or for scanning a scenery, such as for generating a depth profile of an object or of a scenery, e.g. in the field of architecture, metrology, archaeology, arts, medicine, engineering or manufacturing. However, other applications are also possible.

### PRIOR ART

Distance sensors based on triangulation or Time of Flight (ToF) incorporate a distance between light source and detector due to the measurement technology itself or due to mechanical reasons. This distance is called baseline in case of triangulation because of the virtual triangle between light source, detector, and measured target. Similar triangles exist also beam profile analysis systems, although such a triangle is not required for the measurement. With respect to beam profile analysis systems reference is made to WO2018/167215 A1, the full content of which is herewith included by reference.

A system with linear baseline (e.g. a triangulation system) is typically not radially symmetric, in particular not rotationally symmetric, since the optical axes of light source and detector are separated. The separated optical axes lead to optical problems, such as occlusion and the so called Pepita effect.

Occlusion may occur if a light path of the detector is partially occluded. The light source can hit the desired target, but the reflected light does not reach the detector. E.g. such a measurement error may occur in depth measurement of a narrow hole: The light source may shine into the narrow hole but the light returning from the hole does not reach the detector, as the hole is outside the detector's field of view. Occlusion may also refer to the opposite case, where the target is in the field of view of the detector, but the illumination light does not reach the target.

The Pepita effect occurs, when the surface reflectance of the target varies, e.g., on a half bright half dark target. When each half of the light spot from the source is reflected with different intensity, a triangulation detector will not be able to pinpoint the central ray and thus its angle, which is needed to calculate the distance. An asymmetric beam profile analysis system may also yield wrong results.

Further errors may occur if the measured surface is not planar, e.g., if it has triangular or concave shapes such as in corners. If the light spot hits the apex of the triangle, only one half of the spot may be reflected to the triangulation detector, which will distort the measurement. If the spot hits the vertex of a corner wall or one of the segments of this corner, the multiple reflection may distort the measurement also both for ToF and triangulation sensors. In a similar way, this may also distort the spot profile and yield measurement errors in an asymmetric beam profile analysis system.

US 2020/011995 A1 describes a detector for determining a position of at least one object. The detector comprises: at least one angle dependent optical element adapted to generate at least one light beam having at least one beam profile depending on an angle of incidence of an incident light beam propagating from the object towards the detector and illuminating the angle dependent optical element, at least two optical sensors, wherein each optical sensor has at least one light sensitive area, wherein each optical sensor is designed to generate at least one sensor signal in response to an illumination of its respective light-sensitive area by the light beam generated by the angle dependent optical element, at least one evaluation device being configured for determining at least one longitudinal coordinate z of the object by evaluating a combined signal Q from the sensor signals.

GB 2 375 170 A describes a radiation sensor comprising a plurality of probes, e.g. scintillators connected by a plastic optical fiber to a photomultiplier, to sense radiation at different locations e.g. to spatially map a radiation field over a large area such as a patient being treated with Xrays. U.S. Pat. No. 4,978,850 A describes an optical sensor system comprising a measuring head, a light source and a light detector which are connected to each other via flexible optical fiber cables.

U.S. Pat. No. 4,946,275 A describes a distance measurement system for monitoring changes in distances between a source of illumination and a reflective surface. US 2004/114154A1 describes a method for measurement of the distance between a component which is moved past a reference surface.

### Problem Addressed by the Invention

It is therefore an object of the present invention to provide devices and methods facing the above-mentioned technical challenges of known devices and methods. Specifically, it is an object of the present invention to provide devices and methods which reliably may determine a position of an object in space without a baseline, preferably with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

In a first aspect of the present invention a measurement head for determining a position of at least one object is disclosed.

As used herein, the term “measurement head” refers to at least one measuring means configured to receive at least one light beam from the object. The measurement head may comprise at least one spacer device configured to accommodate further components of the measurement head, as will be outlined in detail below. The measurement head may comprise at least one radially arranged or even radially-symmetric design, in particular in view of an arrangement of the optical receiving fibers. The radially arranged or radially symmetric design may allow enhancing robustness of measurement values, in particular at strong black-and-white contrast in a measured point of the object or for measurements of concave or convex surfaces.

As used herein, the term “object” refers to a point or region emitting at least one light beam. The light beam may originate from the object, such as by the object and/or at least one illumination source integrated or attached to the object emitting the light beam, or may originate from a different illumination source, such as from an illumination source directly or indirectly illuminating the object, wherein the light beam is reflected or scattered by the object.

As used herein, the term “position” refers to at least one item of information regarding a location and/or orientation of the object and/or at least one part of the object in space. Thus, the at least one item of information may imply at least one distance between at least one point of the object and the at least one measurement head. As will be outlined in further detail below, the distance may be a longitudinal coordinate or may contribute to determining a longitudinal coordinate of the point of the object. Additionally or alternatively, one or more other items of information regarding the location and/or orientation of the object and/or at least one part of the object may be determined. As an example, additionally, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Additionally or alternatively, the position of the object may imply at least one orientation information of the object, indicating an orientation of the object in space.

The measurement head comprises:
at least one transfer device, wherein the transfer device has at least one focal length in response to the at least one incident light beam propagating from the object to the measurement head, wherein the transfer device comprises a central hole;
at least one bundle of optical fibers, wherein the bundle of optical fibers comprises at least one central optical sending fiber and a plurality of optical receiving fibers arranged radially symmetric around the central optical sending fiber, wherein the central optical sending fiber is configured for sending a light beam for illuminating the object, wherein the optical receiving fibers are configured for receiving the at least one incident light beam propagating from the object to the measurement head having passed the transfer device, wherein the central optical sending fiber is arranged complementary to the central hole, wherein the central optical sending fiber and the optical receiving fibers are arranged such that they have an identical optical axis or a coaxial baseline.

The term “transfer device”, also denoted as “transfer system”, may generally refer to one or more optical elements which are adapted to modify the light beam, such as by modifying one or more of a beam parameter of the light beam, a width of the light beam or a direction of the light beam. The transfer device may be adapted to guide the light beam onto the optical receiving fibers. The transfer device may be configured for collimating the received light. The transfer device may comprise at least one lens or system of lenses. The transfer device may function as a coupling element configured for coupling the light beam travelling from the object to the measurement head into the optical receiving fibers. Therefore the transfer device may be arranged in direction of propagation of the light beam travelling from the object to the measurement head in front of the optical fibers.

The transfer device has a focal length in response to the at least one incident light beam propagating from the object to the measurement head. As used herein, the term “focal length” of the transfer device refers to a distance over which incident collimated rays which may impinge the transfer device are brought into a “focus” which may also be denoted as “focal point”. Thus, the focal length constitutes a measure of an ability of the transfer device to converge an impinging light beam. Thus, the transfer device may comprise one or more imaging elements which can have the effect of a converging lens. By way of example, the transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Optionally, the transfer device can comprise at least one wavelength-selective element, for example at least one optical filter. Optionally, the transfer device can be designed to impress a predefined beam profile on the electromagnetic radiation, for example, at the location of the sensor region and in particular the sensor area. The above-mentioned optional embodiments of the transfer device can, in principle, be realized individually or in any desired combination.

The transfer device may have an optical axis. As used herein, the term “optical axis of the transfer device” generally refers to an axis of mirror symmetry or rotational symmetry of the lens or lens system. In particular, the measurement head and the transfer device have a common optical axis. The optical axis of the measurement head may be a line of symmetry of the optical setup of the measurement head.

The measurement head may comprise at least one transfer system having the at least one transfer device. The transfer system may comprise at least one beam path, with the elements of the transfer system in the beam path being located in a rotationally arranged or even symmetrical fashion with respect to the optical axis. Still, as will also be outlined in further detail below, one or more optical elements located within the beam path may also be off-centered or tilted with respect to the optical axis. In this case, however, the optical axis may be defined sequentially, such as by interconnecting the centers of the optical elements in the beam path, e.g. by interconnecting the centers of the lenses, wherein, in this context, the optical sensors are not counted as optical elements. The optical axis generally may denote the beam path. Therein, the measurement head may have a single beam path along which a light beam may travel from the object to the optical receiving fibers or may have a plurality of beam paths. As an example, a single beam path may be given, or the beam path may be split into two or more partial beam paths. In the latter case, each partial beam path may have its own optical axis. The optical receiving fibers may be located in one and the same beam path or partial beam path. Alternatively, however, the optical receiving fibers may also be located in different partial beam paths.

The transfer device may constitute a coordinate system, wherein a longitudinal coordinate is a coordinate along the optical axis and a transversal coordinate is a coordinate perpendicular thereto. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The transfer device comprises a central hole. The central hole may be a through hole from a first surface of the transfer device to an opposing second surface of the transfer device. The term “hole” generally may refer to a three dimensional recess and/or cutout and/or interruption of the transfer device. The term “central hole” may relate to arrangement of the hole at a center of symmetry and/or a center of gravity of a surface of the transfer device. The center may be on the optical axis of the transfer device. As used herein, the term “geometrical center” of an area generally may refer to a center of gravity of the area. As an example, if an arbitrary point inside or outside the area is chosen, and if an integral is formed over the vectors interconnecting this arbitrary point with each and every point of the area, the integral is a function of the position of the arbitrary point. When the arbitrary point is located in the geometrical center of the area, the integral of the absolute value of the integral is minimized. Thus, in other words, the geometrical center may be a point inside or outside the area with a minimum overall or sum distance from all points of the area.

The term “light beam” generally may refer to an amount of light emitted and/or reflected into a specific direction. Thus, the light beam may be a bundle of the light rays having a predetermined extension in a direction perpendicular to a direction of propagation of the light beam. Preferably, the light beams may be or may comprise one or more Gaussian light beams such as a linear combination of Gaussian light beams, which may be characterized by one or more Gaussian beam parameters, such as one or more of a beam waist, a Rayleigh-length or any other beam parameter or combination of beam parameters suited to characterize a development of a beam diameter and/or a beam propagation in space. As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle. The light beam may have a spatial extension. Specifically, the light beam may have a non-Gaussian beam profile. The beam profile may be selected from the group consisting of a trapezoid beam profile; a triangle beam profile; a conical beam profile. The trapezoid beam profile may have a plateau region and at least one edge region. As used herein, the term “beam profile” generally refers to a transverse intensity profile of the light beam. The beam profile may be a spatial distribution, in particular in at least one plane perpendicular to the propagation of the light beam, of an intensity of the light beam. The light beam specifically may be a Gaussian light beam or a linear combination of Gaussian light beams, as will be outlined in further detail below. Other embodiments are feasible, however. The measurement head may comprise the at least one transfer device configured for one or more of adjusting, defining and determining the beam profile, in particular a shape of the beam profile. As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared spectral range generally refers to electromagnetic radiation in the range of 780 nm to 1 mm, preferably in the range of 780 nm to 3.0 micrometers. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

As used herein, the term “optical fiber” has its ordinary meaning and specifically refers to at least one optical element configured to guide at least partially at least one light beam impinging on an entrance face of the optical fiber to an exit face of the optical fiber. The entrance face and the exit face may be separated from each other by a certain distance and may be connected by at least one light guiding structure. As used herein, the term “to guide at least partially” refers to perfect light guiding and to configurations in which absorptions and reflections from the entrance face and/or absorptions and reflections from or out of the light guiding structure are possible. The term “bundle of optical fibers” may relate to a plurality of optical fibers, such as a set of optical fibers. The measurement head may comprise a plurality of optical receiving fibers, for example a plurality of single optical receiving fibers or a plurality of multifurcated optical receiving fibers. For example, the measurement head may comprise a plurality of single optical receiving fibers, for example optical receiving fibers having identical properties. The optical receiving fibers, i.e. the single optical fibers or multifurcated optical fibers, may be arranged such that the incident light beam may impinge at different angles of incidence into at least two of the optical receiving fibers such that the degree of transmission is different for the optical receiving fibers.

The term “optical receiving fiber” may refer to at least one optical fiber configured for receiving and/or collecting the light beam travelling from the object to the measurement head. Specifically, each of the optical receiving fibers may be and/or may comprise at least one optical measurement fiber. As used herein, the term “optical measurement fiber” refers to the at least one angle dependent optical element having at least one optical fiber configured to provide an incoming light beam to at least one optical sensor. The optical receiving fiber may comprise two ends. The optical receiving fiber may comprise at least one receiving end adapted to receive at least one light beam originating from the object. The optical receiving fiber may comprise at least one exit-end from which the light beam originating from the object leaves the optical receiving fiber. The receiving end may also be denoted as at least one entrance face of the at least one receiving fiber which may also be denoted as the position where the light beam travelling from the object to the measurement head impinges on the optical receiving fiber. Without wishing to be bound by this theory, it is believed that the angle of incidence of a light beam received by the optical receiving fiber is preserved such that the angle of incidence is equal to the exit-angle, assuming that the angle of incidence is equal or smaller than the acceptance angle of the optical receiving fiber. Thus, distance information encoded in the light beam can be essentially preserved and can be evaluated using a combined signal Q, which will be described in detail below.

The optical receiving fibers may be designed such that the degree of transmission may be highest for incoming light rays parallel, i.e. at an angle of 0°, to the optical receiving fiber, neglecting reflection effects. The optical receiving fibers may be designed such that for higher angles, for example angles from 10 to 10°, the degree of transmission may decrease smoothly to around 80% of the degree of transmission for parallel light rays and may remain at this level constantly up to an acceptance angle of the optical receiving fiber. As used herein, the term “acceptance angle” may refer to an angle above which total reflection within the respective optical receiving fiber is not possible such that the light rays are reflected out of the optical receiving fiber. The optical receiving fibers may be designed that at the acceptance angle, the degree of transmission may steeply fall to zero. Light rays having a large angle of incidence may be cut-off.

The optical receiving fibers may be adapted to transmit at least parts of the incident light beam which are not absorbed and/or reflected, between two ends of the respective optical receiving fiber such as an entrance end and an exit end. The optical receiving fibers may have a length and may be adapted to permit transmission over a distance. The optical receiving fibers may comprise at least one material selected from the group consisting of: silica, aluminosilicate glass, germane silicate glass, fluorozirconate, rare earth doped glass, fluoride glass, chalcogenide glasses, sapphire, doped variants, especially for silica glass, phosphate glass, PMMA, polystyrene, fluoropolymers such as poly(perfluoro-butenylvinyl ether), or the like. The optical receiving fibers may be a single or multi-mode fiber. Each of the optical receiving fibers may be or may comprise one or more of a step index fiber, a polarizing fiber, a polarization maintaining fiber, a plastic optical receiving fiber or the like.

Each of the optical receiving fibers may comprise at least one fiber core which is surrounded by at least one fiber cladding. The fiber cladding may have a lower index of refraction as the fiber core. The fiber cladding may also be a double or multiple cladding. The fiber cladding may comprise a so-called outer jacket. The fiber cladding may be coated by a so-called buffer adapted to protect the optical receiving fiber from damages and moisture. The buffer may comprise at least one UV-cured urethane acrylate composite and/or at least one polyimide material. In one embodiment, a refractive index of the fiber core may be higher than the refractive index of the fiber cladding material and the optical receiving fiber may be adapted to guide the incoming light beam by total internal reflection below the angle of acceptance. In one embodiment, the optical receiving fibers may comprise at least one hollow core fiber, also called photonic bandgap fiber. The hollow-core fiber may be adapted to guide the incoming light beam essentially within a so-called hollow region, wherein a minor portion of the light beam is lost due to propagation into the fiber cladding material.

The optical receiving fibers may comprise one or more fiber connectors at the end of the respective optical receiving fiber. The optical receiving fibers may comprise end caps such as coreless end caps. The optical receiving fibers may comprise one or more of a fiber coupler, a fiber Bragg grating, a fiber polarizer, a fiber amplifier, a fiber coupled diode laser, a fiber collimator, a fiber joint, a fiber splicing, a fiber connector, a mechanical splicing, a fusion splicing, or the like. The optical receiving fibers may comprise a polymer coating.

The optical receiving fibers may comprise at least two or more fibers. At least one of the optical receiving fibers may be at least one multifurcated optical fiber, in particular at least one bifurcated optical fiber. For example, the bifurcated optical fiber may comprise two fibers, in particular at least one first fiber and at least one second fiber. The first fiber and the second fiber may be arranged close to each other at an entrance end of the bifurcated optical fiber and may split into two legs separated by a distance at an exit end of the bifurcated optical fiber. The first and second fiber may be designed as fibers having identical properties or may be fibers of different type. The first fiber may be adapted to generate at least one first transmission light beam and the second fiber may be adapted to generate at least one second transmission light beam. The bifurcated optical fiber may be arranged such that the incident light beam may impinge at a first angle of incidence into the first fiber and at a second angle of incidence, different from the first angle, into the second fiber, such that the degree of transmission is different for the first transmission light beam and the second transmission light beam. At least one of the optical receiving fibers may comprise more than two fibers, for example three, four or more fibers. For example, the multifurcated may comprise multiple fibers wherein each fiber may comprise at least one of a core, a cladding, a buffer, a jacket, and one or more fibers may partially or entirely be bundled by a further jacket such as a polymer hose to ensure that the fibers stay close to each other such as at one end of the fiber. All optical receiving fibers may have the same numerical aperture. All optical receiving fibers may be arranged as such, that the light beam propagating from the object to the measurement head impinges on all of the optical receiving fibers between the transfer device and the focal point of the transfer device. The optical receiving fibers may be arranged as such, that the position along the optical axis where the light beam propagating from the object to the measurement head impinges on the optical receiving fibers is identical for all optical receiving fibers. Other arrangements may be possible.

With respect to design and embodiments of the optical receiving fibers reference is made to WO 2020/039084, the full content of which is herewith included by reference.

The optical receiving fibers may have specific mechanical properties to ensure stability of the distance measurement in a broad range of environments. The mechanical properties of the optical receiving fibers may be identical, or the mechanical properties of the optical receiving fibers may differ. Without wishing to be bound by this theory, a the reliability of an optical system comprising optical receiving fibers for measuring in various and rapidly changing environmental conditions relies on relationships of refractive indices and certain energy transport properties. Further certain mechanical parameters may be prerequisite that all functions of the optical system, including the optical receiving fibers, are maintained in a stable way, especially during a change of conditions. Therefore, certain mechanical parameters may act as prerequisite to ensure a stable measurement itself. At least one of the optical receiving fibers and/or the transfer device has a ratio εᵣ/k≥0.362 (m·K)/W. Preferably, at least one of the optical receiving fibers and/or the transfer device has the ratio εᵣ/k≤0.743 (m·K)/W, preferably the ratio is εᵣ/k≤1.133 (m·K)/W. At least one of the optical receiving fibers and/or the transfer device may have a ratio εᵣ/k in the range 0.362 (m·K)/W≤εᵣ/k≤1854 (m·K)/W, wherein k is the thermal conductivity and εᵣ is the relative permittivity. Without wishing to be bound by this theory in environments of rapid heat cycles and/or high temperatures or low temperatures associated with electrical heating devices and/or electrical cooling devices, associated with the electrical fields emitted by these devices and/or electrical spark devices and or heating arc devices, or the like, the use of optical systems within the given range for the quotient of thermal conductivity and the dielectric constant has shown to yield measurement heads with superior stability in these environments. The relative permittivity is also known as the dielectric constant. Preferably, the ratio εᵣ/k is in the range 0.743 (m·K)/W≤εᵣ/k≤194 (m·K)/W. More preferably, the ratio εᵣ/k is in the range 1.133 (m·K)/W εᵣ/k≤88.7 (m·K)/W. At least one of the optical receiving fibers and/or the transfer device may have a relative permittivity in the range 1.02≤εᵣ≤18.5, preferably in the range 1.02≤εᵣ≤14.5, more preferably in the range 1.02≤εᵣ≤8.7, wherein the relative permittivity is measured at 20° C. and 1 kHz. The optical receiving fibers and/or the transfer device may have a thermal conductivity of k≤24 (m·K)/W, preferably k≤17 (m·K)/W, more preferably k≤14 (m·K)/W. The optical receiving fibers and/or the transfer device may have a thermal conductivity of k≥0.003 (m·K)/W, preferably k≥0.007 (m·K)/W, more preferably k≥0.014 (m·K)/W. The thermal conductivity may be measured at 0° C. and <1% relative humidity.

The transfer device may have a ratio vₑ/n_{D} in the range 9.05≤vₑ/n_{D}≤77.3, wherein vₑ is the Abbé-number and no is the refractive index. The Abbé-number vₑ is given by vₑ=(n_{D}−1)/(n_{F}−n_{C}), wherein nᵢ is the refractive index for different wavelengths, wherein n_{C} is the refractive index for 656 nm, n_{D} is the refractive index for 589 nm and n_{F} is the refractive index for 486 nm, measured at room temperature, see e.g. https://en.wikipedia.org/wiki/Abbe_number. Preferably, the ratio vₑ/n_{D} is in the range of 13.9≤vₑ/n_{D}≤44.7, more preferably in the range of 15.8≤vₑ/n_{D}≤40.1. Without wishing to be bound by this theory, refractive indices always depend on manufacturing tolerances. Further, refractive indices are temperature dependent. Further, the wavelength of a light source always has a given tolerance concerning temperature variations. To ensure a stable distance measurement despite quickly changing or very high temperatures or uncontrolled surroundings, the Abbé-number to refractive index quotient may be limited to values that ensure the necessary stability range.

As outlined above, each of the optical receiving fibers may comprise the at least one cladding and the at least one core. A product αΔn may be αΔn≤110 dB/km at at least one wavelength in a visual and near infrared wavelength range, preferably at at least one wavelength selected from 656 nm, 589 nm, or 486 nm, wherein α is the attenuation coefficient and Δn is the refractive index contrast with Δn=(n₁²−n₂²)/(2n₁²), wherein n₁ is the maximum core refractive index and n₂ is the cladding refractive index. Preferably, the product αΔn is αΔn≤23 dB/km, preferably αΔn≤11.26 dB/km. The product αΔn may be in the range 0.0004 dB/km≤αΔn≤110 dB/km at at least one wavelength in a visual and near infrared wavelength range, preferably at at least one wavelength selected from 656 nm, 589 nm, or 486 nm. Preferably, the product αΔn is in the range 0.002 dB/km≤αΔn≤23 dB/km, more preferably in the range 0.02 dB/km≤αΔn≤11.26 dB/km. The refractive index contrast Δn may be in the range 0.0015≤Δn≤0.285, preferably in the range 0.002≤Δn≤0.2750, more preferably in the range 0.003≤Δn≤0.25. The attenuation coefficient of the optical receiving fiber may be in the range 0.2 dB/km≤α≤420 dB/km, preferably in the range 0.25 dB/km≤α≤320 dB/km. The transfer device may have an aperture area D₁ and at least one of the optical receiving fibers may be a fiber core with a cross-sectional area D₂, wherein a ratio D₁/D₂ is in the range 0.54≤D₁/D₂≤5087, preferably 1.27≤D₁/D₂≤413, more preferably 2.17≤D₁/D₂≤59.2. Without wishing to be bound by this theory, limiting the mechanical boundaries of the optical system may result in a strongly improved the measurement stability concerning the optical system. A diameter d_{core} of the core of at least one of the optical receiving fibers may be in the range 2.5 μm≤d_{core}≤10000 μm, preferably in the range 7 μm≤d_{core}≤3000 μm, more preferably in the range 10 μm≤d_{core}≤500 μm. Without wishing to be bound by this theory, the refractive index contrast of optical receiving fibers has shown to be sensitive concerning manufacturing tolerances and/or manufacturing quality while again it is sensitive concerning temperature changes and/or high temperatures. Further, the attenuation coefficient without being related to the refractive index contrast and being mainly influenced by material properties shows a comparable sensitivity to manufacturing quality, temperature changes, high operating temperatures, or the like. Further, the concerned sensitivity of these quantities needs to be limited to a certain range to ensure a proper functioning of the measurement head, if a strong independence of environmental parameters is required.

The optical receiving fibers and/or the transfer device may have a Youngs modulus, also denoted elastic modulus, of less or equal 188 GPa, measured at room temperature, for example by using ultrasonic testing. Preferably the optical receiving fibers and/or the transfer device may have a Youngs modulus of less or equal 167 GPa, more preferably in the range from to 0.0001 GPa to 97 GPa. The optical receiving fibers and/or the transfer device may have a Youngs modulus of greater or equal 0.0001 GPa, preferably of greater or equal 0.007 GPa, more preferably of greater or equal 0.053 GPa.

Each of the optical receiving fibers may have at least one entrance face. A geometric center of the respective entrance face may be aligned perpendicular with respect to an optical axis of the transfer device.

The entrance face of the optical receiving fibers may be oriented and/or orientable towards the object. As used herein, the term “is oriented towards the object” generally refers to the situation that the respective surfaces or openings of the entrance faces are fully or partially visible from the object. Specifically, at least one interconnecting line between at least one point of the object and at least one point of the respective entrance face may form an angle with a surface element of the entrance face which is different from 0°, such as an angle in the range of 20° to 90°, preferably 80 to 90° such as 90°. Thus, when the object is located on the optical axis or close to the optical axis, the light beam propagating from the object towards the measurement head may be essentially parallel to the optical axis.

As used herein, the term “essentially perpendicular” refers to the condition of a perpendicular orientation, with a tolerance of e.g. ±200 or less, preferably a tolerance of ±10° or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less.

The transfer device may be adapted to adjust and/or to change the direction of propagation of the light beam. The transfer device, in particular, may be or may comprise at least one GRIN lens and/or at least one diffractive optical element (DOE). The transfer device may be adapted to influence, for example to divert, the light beam propagating from the object to the measurement head. In particular, the transfer device may be adapted to adjust the direction of propagation of the light beam. The transfer device may be adapted to adjust and/or to generate an angle of propagation with respect to the optical axis of the transfer device. The angle of propagation may be an angle between the optical axis of the transfer device and the direction of propagation of the light beam propagating from the object to the measurement head. Without using a transfer device, the angle of propagation of the light beam may depend primarily on properties of the object, such as surface properties and/or material properties, from which the light beam was generated. The transfer device may be adapted to adjust and/or to generate the angle of propagation such that it is independent from surface properties of the object. The transfer device may be adapted to strengthen and/or to amplify angle dependency of the direction of propagation of the light beam. Without wishing to be bound by theory, the light beam generated by the object may propagate from the object to the measurement head and may impinge on the transfer device under an angle range from 0°, i.e. the optical axis, to an arbitrary angle X, which may be defined by an origin of the scattering on the object to an edge of the transfer device. Since the transfer device may comprise focusing properties, the angle range after passing through the transfer device may differ significantly from the original angle range. For example, light beams impinging parallel to the optical axis may be focused on the focal point or focus. Depending on focusing properties of the transfer device the angle dependency before impinging on the transfer device and after passing through the transfer device may be inverted. The transfer device may be adapted to amplify the angle dependency for a far field, i.e. in case the object is arranged at far distances, wherein light beams are propagating essentially parallel to the optical axis. Generally, without using the transfer device the angle dependency may be greatest in near field regions. In the near field, signals may generally be stronger compared to far field signals. Therefore, a smaller angle dependency in the near field due to a transfer device that amplifies the angle dependency in the far field, may be at least partially compensated by a generally better signal to noise ratio in the near field, and/or by using additional near field properties such as a distance dependent spot-movement due to a non-zero baseline. Additionally or alternatively, for adjusting and/or changing the direction of propagation of the light beam at least one of the optical receiving fibers may be a structured fiber having a shaped and/or structured entrance and/or exit face. Using a structured fiber may allow further increasing the angle dependency of the incoming light beam.

The optical receiving fibers may be arranged in a direction of propagation of the incident light beam propagating from the object to the measurement head behind the transfer device. The optical receiving fibers and the transfer device may be arranged such that the light beam propagating from the object to the measurement head passes through the transfer device before impinging on the optical receiving fibers.

The transfer device such as a GRIN lens and the optical receiving fibers may be configured as one-piece. The optical receiving fibers may be attached to the transfer device such as by a polymer or glue or the like, to reduce reflections at interfaces with larger differences in refractive index. Alternatively, the transfer device and the optical receiving fibers may be arranged spatially separated such as separated in a direction in or parallel to the optical axis. The transfer device and/or the optical receiving fibers may be arranged displaced in a direction perpendicular to the optical axis. The optical receiving fibers may be arranged as such, that the light beam propagating from the object to the measurement head impinges on the optical receiving fibers between the transfer device and the focal point of the transfer device. For example, a distance in a direction parallel to the optical axis between the transfer device and the position where the light beam propagating from the object to the measurement head impinges on the optical receiving fibers may be at least 20% of the focal length, more preferably at least 50% of the focal length, most preferably at least 80% of the focal length. For example, the distance in a direction parallel to the optical axis between the entrance face at least one of the optical receiving fibers receiving the light beam propagating from the object to the measurement head and the transfer device may be at least 20% of the focal length, more preferably at least 50% of the focal length, most preferably at least 80% of the focal length.

Each of the optical receiving fibers may be configured to generate the at least one light beam having at least one beam profile depending on the angle of incidence of the incident light beam propagating from the object towards the measurement head and impinging on the respective optical receiving fiber. In particular, each of the optical receiving fibers may be adapted to influence and/or change and/or adjust the beam profile of the incident light beam. For example, each of the optical receiving fibers may have one or more of angle dependent transmission properties, angle dependent reflection properties or angle dependent absorption properties. The light beam having passed through the respective optical receiving fiber may comprise at least one transmission light beam and/or at least one reflection light beam. The angle of incidence may be measured with respect to an optical axis of the optical receiving fiber such as of the entrance face.

An electromagnetic wave impinging on the entrance face may be partly, depending on the properties of the optical receiving fiber absorbed and/or reflected and/or transmitted. The term “absorption” refers to a reduction of power and/or intensity of the incident light beam by the optical receiving fiber. For example, the power and/or intensity of the incident light beam may be transformed by the optical receiving fiber to heat or another type of energy. As used herein, the term “transmission” refers to a part of the electromagnetic wave which is measurable outside the optical receiving fiber in a half-space with angles from 90° and higher with respect to the optical axis. For example, transmission may be a remaining part of the electromagnetic wave impinging on the entrance face, passing through the optical receiving fiber and leaving the optical receiving fiber at the exit end. The term “reflection” refers to a part of the electromagnetic wave which is measurable outside the optical receiving fiber in a half-space with angles below 90° with respect to the optical axis. For example, reflection may be a change in direction of a wavefront of the incident light beam due to interaction with the optical receiving fiber. The total power of the electromagnetic wave impinging on the optical receiving fiber may be distributed by the optical receiving fiber in at least three components, i.e. an absorption component, a reflection component and a transmission component. A degree of transmission may be defined as power of the transmission component normalized by the total power of the electromagnetic wave impinging on the optical receiving fiber. A degree of absorption may be defined as power of the absorption component normalized by the total power of the electromagnetic wave impinging on the optical receiving fiber. A degree of reflection may be defined as power of the reflection component normalized by the total power of the electromagnetic wave impinging on the optical receiving fiber. Use of at least one transfer device allows to further enhance robustness of the measurement of the longitudinal coordinate. The transfer device may, for example, comprise at least one collimating lens. The optical receiving fibers may be designed to weaken rays impinging with larger angles compared to rays impinging with a smaller angle. For example, the degree of transmission may be highest for light rays parallel to the optical axis, i.e. at 0°, and may decrease for higher angles. In particular, at at least one cut-off angle the degree of transmission may steeply fall to zero. Thus, light rays having a large angle of incidence may be cut-off.

The measurement head may comprise at least one spacer device. The spacer device may be configured for connecting the at least one transfer device and at least one of the optical fibers. The spacer device may be configured to attach the transfer device to at least one of the optical fibers. In case the measurement head comprises a plurality of transfer devices and/or optical fibers, the spacer device may be configured for connecting at least one of the transfer devices with at least one of the optical fibers. Optical paths of the optical fibers may be fully or partially optically separated by mechanical means such as a fully or partially intransparent mechanical wall or cladding or the like to avoid internal reflections. This optical separation by mechanical means may be part of the spacer device. The spacer device may comprise a solid volume Vₛ and a hollow volume Vₕ, also denoted hull volume. The solid volume may be defined by the volume of solid material of which the spacer device consists of. The hull volume may be a convex hull volume. The convex hull volume of the spacer device may be defined as the volume of the smallest convex hull of the solid volume of the spacer device. The hollow volume of the spacer device may be defined as the convex hull volume of the spacer device minus the solid volume of the spacer device. For example, the empty volume may be defined by inner edges of the solid material. A ratio of solid volume and hollow volume Vₛ/Vₕ may be in the range 0.013≤Vₛ/Vₕ≤547, preferably in the range 0.047≤Vₛ/Vₕ≤87.6, more preferably in the range 0.171≤Vₛ/Vₕ≤26.2.

The measurement head may further comprise an illumination source for illuminating the object. The illumination source may be configured for illuminating the object, for example, by directing a light beam towards the object, which reflects the light beam. The illumination source may be configured for generating an illuminating light beam for illuminating the object. Therefore, the illumination source may comprise at least one light source. Specifically, the illumination source may comprise at least one laser and/or laser source. The light source may be or may comprise at least one multiple beam light source. For example, the light source may comprise at least one laser source and one or more diffractive optical elements (DOEs). The illumination source may be adapted to illuminate the object through at least one angle-dependent optical element. Various types of lasers may be employed, such as semiconductor lasers. Additionally or alternatively, non-laser light sources may be used, such as LEDs and/or light bulbs. The illumination source may be adapted to generate and/or to project a cloud of points, for example the illumination source may comprise one or more of at least one digital light processing projector, at least one LCoS projector, at least one spatial light modulator; at least one diffractive optical element; at least one array of light emitting diodes; at least one array of laser light sources. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300 to 1000 nm, especially 500 to 1000 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1000 nm may be used. On account of their generally defined beam profiles and other properties of handleability, the use of at least one laser source as the illumination source is particularly preferred.

The measurement head may comprise one illumination source or a plurality of identical illumination sources and/or a plurality of different illumination sources. For example, the plurality of illumination sources may comprise at least two illumination sources generating light with different properties such as color or modulation frequencies.

The illumination source may have a geometrical extend G in the range 1.5·10⁻⁷ mm²·sr≤G≤314 mm²·sr, preferable in the range 1·10⁻⁵ mm²·sr≤G≤22 mm²·sr, more preferable in the range 3·10⁻⁴ mm²·sr≤G≤3.3 mm²·sr. The geometrical extent G of the illumination source may be defined by

$$G = A \cdot Ω \cdot {n}^{2} ,$$

wherein A is the area of the surface, which can be an active emitting surface, a light valve, optical aperture or the area of the fiber core with A=A_{OF}=π·r²_{OF}, and Ω is the projected solid angle subtended by the light and n is the refractive index of the medium. For rotationally-symmetric optical systems with a half aperture angle θ, the geometrical extend is given by

$$G = π \cdot A \cdot {sin}^{2} ( θ ) {n}^{2} .$$

For optical fibers a divergence angle is obtained by θₘₐₓ=arcsin(NA/n), where NA is the maximum numerical aperture of the optical fiber.

The half aperture angle θ and/or the divergence angle θₘₐₓ may be small. In particular, the half aperture angle θ may be in the range 0.01°≤θ≤42°; preferably in the range of 0.1°≤θ≤21°; more preferably in the range of 0.15°≤θ≤13° and/or the divergence angle θₘₐₓ be in the range 0.01θ≤θₘₐₓ≤42°; preferably in the range of 0.1°≤θₘₐₓ≤21°; more preferably in the range of 0.15°≤θₘₐₓ≤13°. The area A may be small. In particular, the area A may be smaller than 10 mm², preferably smaller than 3 mm², more preferably smaller than 1 mm².

The bundle of optical fibers comprises the at least one central optical sending fiber. The term “optical sending fiber” may relate to at least one optical fiber configured for sending a light beam to the object. The term “central optical sending fiber” may relate to arrangement of the optical sending fiber at a center of symmetry and/or a center of gravity of a surface of the transfer device. The center may be on the optical axis of the transfer device.

The central optical sending fiber may be connectable with the at least one illumination source. The central optical sending fiber may have at least one entrance end. The at least one light source may be positioned at the entrance end. The illumination source may comprise at least one coupling element configured to couple at least one light beam generated by the light source into the central optical sending fiber. The central optical sending fiber may further comprise at least one exit end, wherein the exit end is configured to emit the light beam having passed through the central optical sending fiber.

Further, the illumination source may be configured for emitting modulated or non-modulated light. In case a plurality of illumination sources is used, the different illumination sources may have different modulation frequencies which later on may be used for distinguishing the light beams.

The illuminating light beam generally may be parallel to the optical axis of the measurement head, specifically of the transfer device, or tilted with respect to the optical axis, e.g. including an angle with the optical axis. As an example, the illuminating light beam, such as the laser light beam, and the optical axis may include an angle of less than 10°, preferably less than 5° or even less than 2°. Other embodiments, however, are feasible. Further, the illuminating light beam may be on the optical axis or off the optical axis. As an example, the illuminating light beam may be parallel to the optical axis having a distance of less than 10 mm to the optical axis, preferably less than 5 mm to the optical axis or even less than 1 mm to the optical axis or may even coincide with the optical axis.

The plurality of optical receiving fibers is arranged radially symmetric around the central optical sending fiber. As used herein, the term “radially symmetric” may refer to that the optical receiving fibers are arranged in at least one circle around the central optical sending fiber, wherein opposing optical receiving fibers have identical distance to the central optical sending fiber. For example, the optical receiving fibers may be arranged concentrically around the central optical sending fiber. Each optical receiving fiber may have the at least one entrance face. A geometric center of the respective entrance face may be aligned perpendicular with respect to the optical axis of the transfer device. A geometric center of the respective entrance face may be aligned parallel to the exit face of the central optical sending fiber. The optical receiving fibers may have identical core diameters. The optical receiving fibers may have different core diameters. The measurement head may comprise first optical receiving fibers having smaller core diameter arranged radially symmetric around the central optical sending fiber and second optical receiving fibers having greater core diameter arranged radially symmetric around the central optical sending fiber. The first optical receiving fibers may be configured for sampling an inner part of an image of the object, wherein the second optical receiving fibers may be configured for sample the whole image of the object. Since an image of the object received by optical receiving fibers is also annular, the part of the image with the highest intensity may not be lost. By dividing the signals from one of the first and one of the second optical fibers, a combined signal can be calculated and the distance can be determined.

The central optical sending fiber is arranged complementary to the central hole. As used herein, the term “arranged complementary” may refer to arrangement of the central optical sending fiber directly or indirectly within and/or through the central hole. The exit face of the central optical sending fiber may have the same or different diameter than a diameter of the central hole. For example, the central optical sending fiber may be fed through the central hole. For example, the central optical sending fiber may be connected with a GRIN lens arranged within the central hole of the transfer device. In known measurement heads with a full lens, the reflection of the illumination light at the back surface of the lens may lead to an offset and falsify the measurement. A hole in the middle of the lens may allow to solves this problem. The central optical sending fiber may be fed through the transfer device, to avoid back-reflections. Optionally, the central optical sending fiber can be connected with a GRIN Lens, which goes through the hole. In both cases, the reflection at the back end may be prevented.

The central optical sending fiber and the optical receiving fibers are arranged such that they have an identical optical axis. Specifically, the measurement head may have no baseline. In particular, the baseline may be a distance between at least one illumination channel and at least one receiver channel. Specifically, a distance, for example in a xy-plane, between at least one illumination channel and at least one receiver channel may be as small as possible. As used herein, the term “illumination channel” refers to at least one optical channel comprising the central optical sending fiber. As used herein, the term “receiver channel” refers to at least one optical channel comprising at least one of the optical receiving fibers adapted to receive the light beam propagating from the object to the measurement head. The receiver channel may comprise at least one receiver-optics such as the at least one transfer device. Specifically, the term “baseline” refers to a distance between the position where the light beam propagating from the object to the measurement head impinges on the optical receiving fibers, in particular at least one entrance face or end of the at least one optical receiving fiber, and the exit face of the central optical sending fiber.

For example, the transfer device may be a radially symmetric lens. The term “radially symmetric lens” may generally refer to a transfer device having a symmetry in which the transfer device is invariant to all rotations, in particular around all axes through a center of symmetry. The radially symmetric lens may be a spherical or an aspherical lens. The central optical sending fiber may be fed through the central hole. Specifically, the measurement head may comprise a single standard lens in front of the coaxial bundle of optical fibers, where the light is sent through the central optical sending fiber and received by the optical receiving fibers. In this case, the central optical sending fiber and the optical receiving fibers will have the same optical axis, and on axis measurement can be achieved.

The central optical sending fiber and the optical receiving fibers are arranged such that they have a coaxial baseline. For example, the transfer device may be an annular axial lens, for example a lens having a torus form. The annular axial lens may be a spherical or aspherical lens. The annular axial lens may allow preventing that the photons accepted by the lens may be mainly focused to the central optical sending fiber, where some of the photons are absorbed or reflected without hitting the optical receiving fibers, and that the central part, which yields the highest intensity is lost. Both effects would lead to a strong radiant power loss. The annular axial lens may be more efficient in feeding the received light to the optical receiving fibers. The curvature of the lens can be spherical or aspherical, depending on the application. In this embodiment, the optical axes of the central optical sending fiber and the optical receiving fibers may be separated by a coaxial baseline. However, the “baseline” between the central optical sending fiber and optical receiving fibers may not be linear, but radial. This may allow a coaxial, on axis measurement. The optical receiving fibers may be arranged in a blur range of the annular axial lens, in particular a radial symmetric lens, such that it may be possible to determine a blurred image. Such a design, in particular lens design, may allow measurements using information from beam profile analysis as described herein.

Beam profile analysis may allow distance measurements without a baseline. Alike ToF, the baseline may not be needed for the measurement itself. However, due to manufacturing restrictions, it typically difficult to position the light source and the detector coaxially. Such a coaxial setup can be realized by using the optical fiber bundle according to the present invention. Such an arrangement cannot be used for ToF measurements, since multi-mode fibers significantly deteriorate the measurement. However, for beam profile analysis using of such a setup may be advantageous. The radially symmetric measurement head may allow eliminating occlusion errors. Errors arising due to non-flat target surfaces can be compensated to a certain level. The pepita effect can be eliminated, as long as the beam spot is in the middle of the non-uniform target.

The blur circle diameter 2r of an image behind the axial annular lens may be given as

$$r = Dq \vert 1 / f - 1 / z - 1 / q \vert ;$$

where D is the clear aperture of the lens, q is the distance of a sensor plane from the lens, f is the focal length of the lens and z is the object distance. If Δr can be sensed by a detector, the distance change can be detected. Moreover, disparity ρ of the image in a triangulation system can be calculated as

$$p = fd / z ;$$

where d is the baseline between light source and detector. If the lens diameter and the baseline are equal and the sensor plane is positioned in the focal distance of the lens, the dynamic range of triangulation and blur circle variation is the same. Due to mechanical and cost reasons, the baseline of a beam profile system according to the present invention may be in principle larger than the diameter of the lens, which makes the disparity a dominant effect and all the drawbacks related to it also exist in the beam profile system. However, in case of using the annular axial lens this problem may be solved in the following way: The distance between the optical axes of the central optical sending fiber and the optical receiving fibers may act as a baseline, which leads to a spot movement on the sensor plane with varying target distance. By adequately choosing the inner diameter of the annular lens, which corresponds to the outer diameter of the sending fiber, and the clear aperture of the annular lens, the ratio between baseline and clear aperture can be reduced. In this way, the blur circle variation may be the dominant change in the system. The clear aperture of the axial annular lens may not be the outer diameter of the lens but may depend on the curvature and the radius of the ring. Moreover, the use of the axial annular lens, object size independent distance measurement may be possible. A very characteristic feature of the beam profile analysis is the object size independency. By adequately positioning the fibers behind the axial annular lens, the distance measurement may be object size independent.

The measurement head may comprise at least one actuator configured to move the measurement head to scan a region of interest. As used herein, the term “move” refers to driving the measurement head and/or to causing the measurement head to oscillate. As used herein, the term “actuator” refers to an arbitrary device adapted to generate a force causing the measurement head to move. Specifically, the actuator may be attached and/or coupled and/or connected to the optical receiving fibers and/or central optical sending fiber and may be adapted to generate a force causing the optical receiving fibers and/or central optical sending fiber to move, in particular to oscillate. The actuator may be adapted to generate a force corresponding to a harmonic of a natural resonant frequency of the optical receiving fibers and/or central optical sending fiber. The actuator may comprise at least one electromechanical actuator and/or at least one piezo actuator. The piezo actuator may comprise at least one actuator selected from the group consisting of: at least one piezoceramic actuator; at least one piezoelectric actuator. The actuator may be configured to cause the measurement head, specifically the optical illumination fiber and/or the optical receiving fibers to oscillate. The actuator may be adapted to move the measurement head in a linear scan and/or a radial scan and/or a spiral scan. For example, the actuator may be adapted to generate a force on the measurement head such that the measurement head moves upwards and downwards. For example, the actuator may be configured to generate a force on the measurement head such that the measurement head moves in an orbit with a predefined radius. The radius may be adjustable. For example, the actuator may be adapted to generate a force such that the measurement head moves in a spiral such as with a radius which alternately decreases or increases.

In a further aspect of the present invention, a kit for determining a position of at least one object is disclosed. The kit comprises at least one measurement head according to the embodiments disclosed above and/or according to one or more of the embodiments disclosed in further detail below. The kit further comprises at least one detector comprising
a plurality of optical sensors, wherein each optical sensor has at least one light sensitive area, wherein each optical sensor is designed to generate at least one sensor signal in response to an illumination of its respective light-sensitive area by a light beam having passed through at least one of the optical receiving fibers of the measurement head;
at least one evaluation device being configured for determining at least one longitudinal coordinate z of the object by evaluating a combined signal Q from the sensor signals.

As used herein, an “optical sensor” generally refers to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination the at least one sensor signal is generated. The light-sensitive area may specifically be located on a surface of the respective optical sensor. Other embodiments, however, are feasible. As used herein, the term “at least two optical sensors each having at least one light sensitive area” refers to configurations with two single optical sensors each having one light-sensitive area and to configurations with one combined optical sensor having at least two light-sensitive areas. Thus, the term “optical sensor” furthermore refers to a light-sensitive device configured to generate one output signal, whereas, herein, a light-sensitive device configured to generate two or more output signals, for example at least one CCD and/or CMOS device, is referred to as two or more optical sensors. As will further be outlined in detail below, each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the set-up. Other embodiments, however, are feasible. Thus, as an example, an optical device comprising two, three, four or more than four light-sensitive areas may be used which is regarded as two, three, four or more than four optical sensors in the context of the present invention. As an example, the optical device may comprise a matrix of light-sensitive areas. Thus, as an example, the optical sensors may be part of or constitute a pixelated optical device. As an example, the optical sensors may be part of or constitute at least one CCD and/or CMOS device having a matrix of pixels, each pixel forming a light-sensitive area.

Each of the optical receiving fibers may be configured to emit the at least one light beam such that the light beam impinges on the light-sensitive areas. For example, in case at least one of the light-sensitive areas is oriented under the arbitrary angle with respect to the optical axis, the optical receiving fibers may be adapted to guide the light beam onto the light-sensitive area.

As further used herein, a “sensor signal” generally refers to a signal generated by an optical sensor in response to the illumination by the light beam. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

The optical sensor specifically may be or may comprise at least one photodetector, preferably inorganic photodetectors, more preferably inorganic semiconductor photodetectors, most preferably silicon photodetectors. Specifically, the optical sensor may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor may be or may comprise at least one inorganic photodiode which are sensitive in the infrared spectral range, preferably in the range of 700 nm to 3.0 micrometers. Specifically, the optical sensor may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor may comprise at least one photoconductive sensor such as a PbS or PbSe sensor, a bolometer, preferably a bolometer selected from the group consisting of a VO bolometer and an amorphous Si bolometer.

The optical sensors may be sensitive in one or more of the ultraviolet, the visible or the infrared spectral range. Specifically, the optical sensors may be sensitive in the visible spectral range from 500 nm to 780 nm, most preferably at 650 nm to 750 nm or at 690 nm to 700 nm. Specifically, the optical sensors may be sensitive in the near infrared region. Specifically, the optical sensors may be sensitive in the part of the near infrared region where silicon photodiodes are applicable specifically in the range of 700 nm to 1000 nm. The optical sensors, specifically, may be sensitive in the infrared spectral range, specifically in the range of 780 nm to 3.0 micrometers. For example, the optical sensors each, independently, may be or may comprise at least one element selected from the group consisting of a photodiode, a photocell, a photoconductor, a phototransistor or any combination thereof. For example, the optical sensors may be or may comprise at least one element selected from the group consisting of a CCD sensor element, a CMOS sensor element, a photodiode, a photocell, a photoconductor, a phototransistor or any combination thereof. Any other type of photosensitive element may be used. As will be outlined in further detail below, the photosensitive element generally may fully or partially be made of inorganic materials and/or may fully or partially be made of organic materials. Most commonly, as will be outlined in further detail below, one or more photodiodes may be used, such as commercially available photodiodes, e.g. inorganic semiconductor photodiodes.

At least one optical sensor may be arranged at the exit ends of each optical receiving fiber. Alternatively, at least two or more of the optical receiving fibers may use the same optical sensor. The optical sensors at the end of the optical receiving fibers may be arranged as such that at least 80%, preferably at least 90%, more preferably at least 99% of the luminance power of the light beams exiting the optical receiving fiber towards the optical sensors impinge on at least one optical sensor. A position relative to the transfer device where the light beam travelling from the object to the measurement device impinges on the optical receiving fibers may be optimized to obtain a combined signal Q with a high dynamic range.

For example, the detector may comprise at least one sensor element having a matrix of optical sensors, the optical sensors each having a light-sensitive area, wherein each optical sensor may be configured to generate at least one sensor signal in response to an illumination of the light-sensitive area by the light beam having passed through one or more optical receiving fibers. As used herein, the term “sensor element” generally refers to a device or a combination of a plurality of devices configured for sensing at least one parameter. In the present case, the parameter specifically may be an optical parameter, and the sensor element specifically may be an optical sensor element. The sensor element may be formed as a unitary, single device or as a combination of several devices. As further used herein, the term “matrix” generally refers to an arrangement of a plurality of elements in a predetermined geometrical order. The matrix, as will be outlined in further detail below, specifically may be or may comprise a rectangular matrix having one or more rows and one or more columns. The rows and columns specifically may be arranged in a rectangular fashion. It shall be outlined, however, that other arrangements are feasible, such as nonrectangular arrangements. As an example, circular arrangements are also feasible, wherein the elements are arranged in concentric circles or ellipses about a center point. For example, the matrix may be a single row of pixels. Other arrangements are feasible. The optical sensors of the matrix specifically may be equal in one or more of size, sensitivity and other optical, electrical and mechanical properties. The light-sensitive areas of all optical sensors of the matrix specifically may be located in a common plane, the common plane preferably facing the object, such that the light beam having passed through the optical receiving fibers may generate a light spot on the common plane.

The use of a matrix of optical sensors provides a plurality of advantages and benefits. Thus, the center of the light spot generated by the light beam on the sensor element, such as on the common plane of the light-sensitive areas of the optical sensors of the matrix of the sensor element, may vary with a transversal position of the object. The transversal position of the light spot on the matrix of optical sensors, such as the transversal position of the at least one optical sensor generating the sensor signal, may even be used as an additional item of information, from which at least one item of information on a transversal position of the object may be derived, as e.g. disclosed in WO 2014/198629 A1. Additionally or alternatively, as will be outlined in further detail below, the detector according to the present invention may contain at least one additional transversal detector for, in addition to the at least one longitudinal coordinate, detecting at least one transversal coordinate of the object.

As further used herein, the term “evaluation device” generally refers to an arbitrary device adapted to perform the named operations, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands. The evaluation device may provide one or more hardware elements for performing one or more of the named operations and/or may provide one or more processors with software running thereon for performing one or more of the named operations. Thus, as an example, the evaluation device may comprise one or more programmable devices such as one or more computers, application-specific integrated circuits (ASICs), Digital Signal Processors (DSPs), or Field Programmable Gate Arrays (FPGAs) which are configured to perform the above-mentioned controlling. Additionally or alternatively, however, the evaluation device may also fully or partially be embodied by hardware.

The evaluation device may be or may comprise one or more integrated circuits, such as one or more application-specific integrated circuits (ASICs), and/or one or more data processing devices, such as one or more computers, preferably one or more microcomputers and/or microcontrollers, Field Programmable Arrays, or Digital Signal Processors. Additional components may be comprised, such as one or more preprocessing devices and/or data acquisition devices, such as one or more devices for receiving and/or preprocessing of the sensor signals, such as one or more AD-converters and/or one or more filters. Further, the evaluation device may comprise one or more measurement devices, such as one or more measurement devices for measuring electrical currents and/or electrical voltages. Further, the evaluation device may comprise one or more data storage devices. Further, the evaluation device may comprise one or more interfaces, such as one or more wireless interfaces and/or one or more wire-bound interfaces.

The evaluation device can be connected to or may comprise at least one further data processing device that may be used for one or more of displaying, visualizing, analyzing, distributing, communicating or further processing of information, such as information obtained by the optical sensor and/or by the evaluation device. The data processing device, as an example, may be connected or incorporate at least one of a display, a projector, a monitor, an LCD, a TFT, a loudspeaker, a multichannel sound system, an LED pattern, or a further visualization device. It may further be connected or incorporate at least one of a communication device or communication interface, a connector or a port, capable of sending encrypted or unencrypted information using one or more of email, text messages, telephone, Bluetooth, Wi-Fi, infrared or internet interfaces, ports or connections. It may further be connected to or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phase-locked loops, counter-timers, real-time timers, or power-on reset generators, voltage regulators, power management circuits, or DMA controllers. Individual units may further be connected by buses such as AMBA buses or be integrated in an Internet of Things or Industry 4.0 type network.

The evaluation device and/or the data processing device may be connected by or have further external interfaces or ports such as one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices such as a 2D-camera device using an RGB-interface such as CameraLink. The evaluation device and/or the data processing device may further be connected by one or more of interprocessor interfaces or ports, FPGA-FPGA-interfaces, or serial or parallel interfaces ports. The evaluation device and the data processing device may further be connected to one or more of an optical disc drive, a CD-RW drive, a DVD+RW drive, a flash drive, a memory card, a disk drive, a hard disk drive, a solid state disk or a solid state hard disk. The evaluation device and/or the data processing device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors.

The light beam, in particular the image of the object, received by the optical receiving fibers may comprise a beam profile. As used herein, the term “beam profile” may generally refer to at least one intensity distribution, such as of a light spot on the optical sensor, as a function of the pixel. The beam profile may be selected from the group consisting of a trapezoid beam profile; a triangle beam profile; a conical beam profile and a linear combination of Gaussian beam profiles.

The evaluation device is configured for determining at least one longitudinal coordinate z of the object by evaluating a combined signal Q of the sensor signals. Determining the longitudinal coordinate z by using a combined signal Q of the sensor signals is called beam profile analysis or depth-from-photon-ratio (DPR) technique. With respect to determining the longitudinal coordinate z by using a combined signal Q of the sensor signals reference is made to WO 2018/091649 A1, WO 2018/091638 A1 and WO 2018/091640 A1, the full content of which is included by reference.

The evaluation device may be configured for determining the at least one longitudinal coordinate by analysis of beam profiles. As used herein, the term “analysis of the beam profile” may generally refer to evaluating of the beam profile and may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device may be configured for symmetrizing and/or for normalizing and/or for filtering the beam profile, in particular to remove noise or asymmetries from recording under larger angles, recording edges or the like. The evaluation device may filter the beam profile by removing high spatial frequencies such as by spatial frequency analysis and/or median filtering or the like. Summarization may be performed by center of intensity of the light spot and averaging all intensities at the same distance to the center. The evaluation device may be configured for normalizing the beam profile to a maximum intensity, in particular to account for intensity differences due to the recorded distance. The evaluation device may be configured for removing influences from background light from the beam profile, for example, by an imaging without illumination.

The evaluation device is configured for determining at least one longitudinal coordinate z of the object by evaluating a combined signal Q from the sensor signals. As generally used herein, the term “combine” generally may refer to an arbitrary operation in which two or more components such as signals are one or more of mathematically merged in order to form at least one merged combined signal and/or compared in order to form at least one comparison signal or comparison result. As used herein, the term “combined signal Q” refers to a signal which is generated by combining the sensor signals, in particular by one or more of dividing the sensor signals, dividing multiples of the sensor signals or dividing linear combinations of the sensor signals. In particular, the combined signal may be a quotient signal. The combined signal Q may be determined by using various means. As an example, a software means for deriving the combined signal, a hardware means for deriving the combined signal, or both, may be used and may be implemented in the evaluation device. Thus, the evaluation device, as an example, may comprise at least one divider, wherein the divider is configured for deriving the quotient signal. The divider may fully or partially be embodied as one or both of a software divider or a hardware divider.

The evaluation device may be configured for determining the combined signal Q by one or more of dividing the first area and the second area, dividing multiples of the first area and the second area, dividing linear combinations of the first area and the second area. The evaluation device may be configured for deriving the quotient Q by

$$Q = \frac{\int {\int }_{A 1} E ( x , y ) dxdy}{\int {\int }_{A 2} E ( x , y ) dxdy}$$

wherein x and y are transversal coordinates, A1 and A2 are the first and second area of the beam profile, respectively, and E(x,y) denotes the beam profile.

The analysis of the beam profile may comprise determining at least one first area and at least one second area of the beam profile. The first area of the beam profile may be an area A1 and the second area of the beam profile may be an area A2. The evaluation device may be configured for integrating the first area and the second area. The evaluation device may be configured to derive a combined signal, in particular a quotient Q, by one or more of dividing the integrated first area and the integrated second area, dividing multiples of the integrated first area and the integrated second area, dividing linear combinations of the integrated first area and the integrated second area. The evaluation device may configured for determining at least two areas of the beam profile and/or to segment the beam profile in at least two segments comprising different areas of the beam profile, wherein overlapping of the areas may be possible as long as the areas are not congruent. For example, the evaluation device may be configured for determining a plurality of areas such as two, three, four, five, or up to ten areas. The evaluation device may be configured for segmenting the light spot into at least two areas of the beam profile and/or to segment the beam profile in at least two segments comprising different areas of the beam profile. The evaluation device may be configured for determining for at least two of the areas an integral of the beam profile over the respective area. The evaluation device may be configured for comparing at least two of the determined integrals. Specifically, the evaluation device may be configured for determining at least one first area and at least one second area of the beam profile. As used herein, the term “area of the beam profile” generally refers to an arbitrary region of the beam profile at the position of the optical sensor used for determining the combined signal Q. The first area of the beam profile and the second area of the beam profile may be one or both of adjacent or overlapping regions. The first area of the beam profile and the second area of the beam profile may be not congruent in area. For example, the evaluation device may be configured for dividing a sensor region of the optical sensor into at least two sub-regions, wherein the evaluation device may be configured for dividing the sensor region of the CMOS sensor into at least one left part and at least one right part and/or at least one upper part and at least one lower part and/or at least one inner and at least one outer part. Additionally or alternatively, the sensor signals of at least two optical sensors may be used, wherein the light-sensitive areas of a first optical sensor and of a second optical sensor may be arranged such that the first optical sensor is adapted to determine the first area of the beam profile and that the second optical sensor is adapted to determine the second area of the beam profile. The evaluation device may be adapted to integrate the first area and the second area.

The first area of the beam profile may comprise essentially edge information of the beam profile and the second area of the beam profile comprises essentially center information of the beam profile, and/or the first area of the beam profile may comprise essentially information about a left part of the beam profile and the second area of the beam profile comprises essentially information about a right part of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. As used herein, the term “essentially center information” generally refers to a low proportion of edge information, i.e. proportion of the intensity distribution corresponding to edges, compared to a proportion of the center information, i.e. proportion of the intensity distribution corresponding to the center. Preferably, the center information has a proportion of edge information of less than 10%, more preferably of less than 5%, most preferably the center information comprises no edge content. As used herein, the term “essentially edge information” generally refers to a low proportion of center information compared to a proportion of the edge information. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region.

For example, as outlined above, the optical receiving fibers may be arranged to form a radially symmetric measurement head. The optical receiving fibers may have different core diameters, e.g. first optical receiving fibers having a smaller core diameter and second optical receiving fibers having a larger core diameter. The cores with the smaller diameter, which constitute the first optical receiving fibers, may sample a central part of the image, i.e. the beam profile. The larger cores of the second optical receiving fibers may sample the whole image, i.e. central and edge regions of the beam profile. The evaluation device may be configured for determining the combined signal by dividing the signals from both first and second optical receiving fibers.

The evaluation device may be configured for using at least one predetermined relationship between the combined signal Q and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

The detector may be configured for evaluating a single light beam or a plurality of light beams. In case a plurality of light beams propagates from the object to the detector, means for distinguishing the light beams may be provided. Thus, the light beams may have different spectral properties, and the detector may comprise one or more wavelength selective elements for distinguishing the different light beams. Each of the light beams may then be evaluated independently. The wavelength selective elements, as an example, may be or may comprise one or more filters, one or more prisms, one or more gratings, one or more dichroitic mirrors or arbitrary combinations thereof. Further, additionally or alternatively, for distinguishing two or more light beams, the light beams may be modulated in a specific fashion. Thus, as an example, the light beams may be frequency modulated, and the sensor signals may be demodulated in order to distinguish partially the sensor signals originating from the different light beams, in accordance with their demodulation frequencies. These techniques generally are known to the skilled person in the field of high-frequency electronics. Generally, the evaluation device may be configured for distinguishing different light beams having different modulations.

As outlined above, the detector may further comprise one or more additional elements such as one or more additional optical elements. Further, the detector may fully or partially be integrated into at least one housing.

The kit further may comprise at least one beacon device adapted to direct at least one light beam towards the detector, wherein the beacon device is at least one of attachable to the object, holdable by the object and integratable into the object. The at least one beacon device may be or may comprise at least one active beacon device, comprising one or more illumination sources such as one or more light sources like lasers, LEDs, light bulbs or the like. As an example, the light emitted by the illumination source may have a wavelength of 300 to 1000 nm, especially 500 to 1000 nm. Alternatively, as outlined above, the infrared spectral range may be used, such as in the range of 780 nm to 3.0 μm. Specifically, the near infrared region where silicon photodiodes are applicable specifically in the range of 700 nm to 1000 nm may be used. The light emitted by the one or more beacon devices may be non-modulated or may be modulated, as outlined above, in order to distinguish two or more light beams. Additionally or alternatively, the at least one beacon device may be adapted to reflect one or more light beams towards the detector, such as by comprising one or more reflective elements. Further, the at least one beacon device may be or may comprise one or more scattering elements adapted for scattering a light beam. Therein, elastic or inelastic scattering may be used. In case the at least one beacon device is adapted to reflect and/or scatter a primary light beam towards the detector, the beacon device may be adapted to leave the spectral properties of the light beam unaffected or, alternatively, may be adapted to change the spectral properties of the light beam, such as by modifying a wavelength of the light beam.

In a further aspect of the present invention, use of the measurement head and/or the kit according to the present invention, such as according to one or more of the embodiments given above or given in further detail below, is proposed, for a purpose of use, selected from the group consisting of: a position measurement in traffic technology; an entertainment application; an optical data storage application; a security application; a surveillance application; a safety application; a human-machine interface application; a tracking application; a photography application; an imaging application or camera application; an industrial sensing application; a medical application; a 3D printing application; a mapping application for generating maps of at least one space; a homing or tracking beacon detector for vehicles; a machine vision application; a robotics application; a quality control application; a manufacturing application; a rotational scanner; laser drilling machine.

The measurement head and/or the kit may be used for a rotational scanner. Rotational scanners based on ToF or triangulation sensors may be built similar to each other: the whole optical setup and corresponding electronics should be rotated. The connection to the rest of the electronics, e.g. read-out, power supply etc., may be achieved with the help of slip rings. The slip rings may be expensive components reducing the life span of the system, since they are in most cases the first components to fail. A periscopic system, where only the top mirror may be rotating is a possibility to remove the slip rings. But this setup may be very expensive to build, since it requires more optical and mechanical elements, e.g., a dove prism, to remove the image tilt, by rotating the dove prism by the half degree of rotation of the top mirror. A radially symmetric measurement head according to the present invention may be positioned next to the periscope in such a way, that the optical axes of the mirrors and the optical axis of the measurement head coincide. The image tilt may be compensated by the rotational symmetry and a rotational scanner without any slip ring with only a rotating mirror can be realized.

The measurement head and/or the kit may be used as laser drilling machine. Laser drilling machines may require on-axis depth measurement to fully automate the process. Measurement systems with a baseline lead to occlusion effects. With the help of the measurement head according to the present invention, this problem can be solved.

For further uses of the measurement head and kit according to the present application, reference is made to WO 2018/091640 A1, the full content of which is herewith included by reference.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. Herein, in most cases, when referring to the respective feature or element, the expressions “at least one” or “one or more” are not repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

Overall, in the context of the present invention, the following embodiments are regarded as preferred:
Embodiment 1 A measurement head for determining a position of at least one object comprising:
   at least one transfer device, wherein the transfer device has at least one focal length in response to the at least one incident light beam propagating from the object to the measurement head, wherein the transfer device comprises a central hole;
   at least one bundle of optical fibers, wherein the bundle of optical fibers comprises at least one central optical sending fiber and a plurality of optical receiving fibers arranged radially symmetric around the central optical sending fiber, wherein the central optical sending fiber is configured for sending a light beam for illuminating the object, wherein the optical receiving fibers are configured for receiving the at least one incident light beam propagating from the object to the measurement head having passed the transfer device, wherein the central optical sending fiber is arranged complementary to the central hole, wherein the central optical sending fiber and the optical receiving fibers are arranged such that they have an identical optical axis or a coaxial baseline.
Embodiment 2 The measurement head according to the preceding embodiment, wherein the central optical sending fiber is fed through the central hole.
Embodiment 3 The measurement head according to any one of the preceding embodiments, wherein the central optical sending fiber is connected with a GRIN lens arranged within the central hole of the transfer device.
Embodiment 4 The measurement head according to any one of the preceding embodiments, wherein the central optical sending fiber is connectable with at least one illumination source.
Embodiment 5 The measurement head according to any one of the preceding embodiments, wherein the transfer device is a radially symmetric lens, wherein the radially symmetric lens is a spherical or an aspherical lens.
Embodiment 6 The measurement head according to any one of the preceding embodiments, wherein the transfer device is an annular axial lens, wherein the annular axial lens is a spherical or aspherical lens.
Embodiment 7 The measurement head according to the preceding embodiment, wherein the optical axes of the central optical sending fiber and the optical receiving fibers are separated by a coaxial baseline.
Embodiment 8 The measurement head according to any one of the preceding embodiments, wherein the optical receiving fibers have different core diameters.
Embodiment 9 The measurement head according to the preceding embodiment, wherein the measurement head comprises first optical receiving fibers having smaller core diameter arranged radially symmetric around the central optical sending fiber and second optical receiving fibers having greater core diameter arranged radially symmetric around the central optical sending fiber, wherein the first optical receiving fibers are configured for sampling an inner part of an image of the object, wherein the second optical receiving fibers are configured for sample the whole image of the object.
Embodiment 10 The measurement head according to any one of the preceding embodiments, wherein each optical receiving fiber has at least one entrance face, wherein a geometric center of the respective entrance face is aligned perpendicular with respect to an optical axis of the transfer device.
Embodiment 11 A kit comprising at least one measurement head according to any one of the preceding embodiments and a detector for determining a position of at least one object, the detector comprising:
   a plurality of optical sensors, wherein each optical sensor has at least one light sensitive area, wherein each optical sensor is designed to generate at least one sensor signal in response to an illumination of its respective light-sensitive area by a light beam having passed through at least one of the optical receiving fibers of the measurement head;
   at least one evaluation device being configured for determining at least one longitudinal coordinate z of the object by evaluating a combined signal Q from the sensor signals.
Embodiment 12 The kit according to the preceding embodiment, wherein the evaluation device is configured for deriving the combined signal Q by one or more of dividing the sensor signals, dividing multiples of the sensor signals, dividing linear combinations of the sensor signals.
Embodiment 13 The kit according to the preceding embodiment, wherein the evaluation device is configured for using at least one predetermined relationship between the combined signal Q and the longitudinal coordinate for determining the longitudinal coordinate.
Embodiment 14 A use of the measurement head according to any one of the preceding embodiments relating to a measurement head, for a purpose of use, selected from the group consisting of: a position measurement in traffic technology; an entertainment application; an optical data storage application; a security application; a surveillance application; a safety application; a human-machine interface application; a logistics application; an endoscopy application; a medical application; a tracking application; a photography application; a machine vision application; a robotics application; a quality control application; a 3D printing application; an augmented reality application; a manufacturing application; a use in combination with optical data storage and readout; a rotational scanner; a laser drilling machine.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an embodiment of a measurement head according to the present invention;

FIG. 2 shows a further embodiment of the measurement head according to the present invention;

FIG. 3 shows an embodiment of a kit according to the present invention;

FIGS. 4A and 4B show cross sections of a fiber arrangement of the measurement head;

FIG. 5 shows radial beam profile for different object diameters at different object distances;

FIG. 6 shows combined signals as a function of target distance for different object sizes; and

FIG. 7 shows a schematic drawing of an embodiment of a laser drilling machine according to the present invention with on-axis distance measurement.

### DETAILED DESCRIPTION OF THE EMBODIMENTS

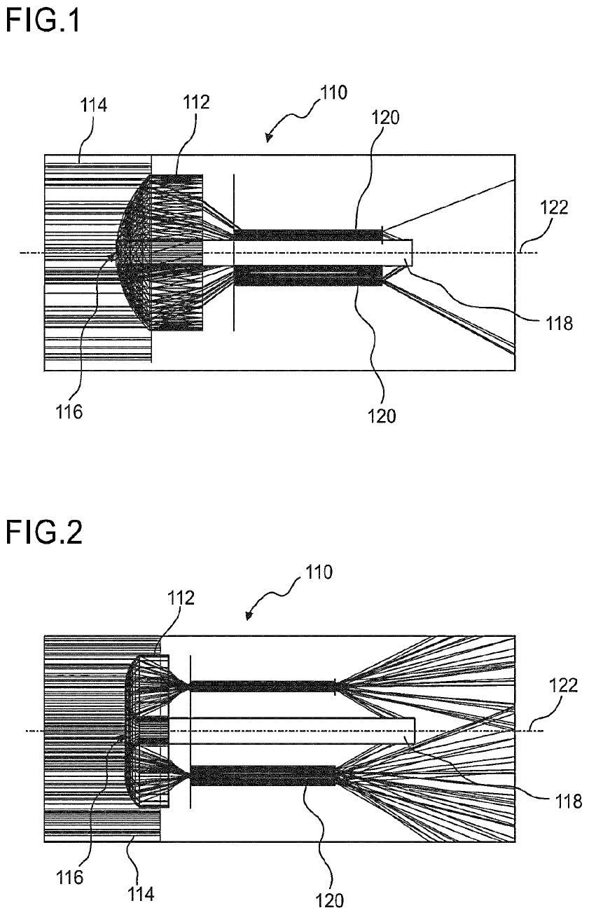

FIGS. 1 and 2 show embodiments of a measurement head 110 according to the present invention for determining a position of at least one object. The measurement head 110 comprises at least one transfer device 112. The transfer device 112 has at least one focal length in response to the at least one incident light beam 114 propagating from the object to the measurement head 110. The transfer device 112 comprises a central hole 116. The measurement head 110 further comprises at least one bundle of optical fibers, wherein the bundle of optical fibers comprises at least one central optical sending fiber 118 and a plurality of optical receiving fibers 120 arranged radially symmetric around the central optical sending fiber 118. The central optical sending fiber 118 is configured for sending a light beam for illuminating the object. The optical receiving fibers 120 are configured for receiving the at least one incident light beam propagating from the object to the measurement head 110 having passed the transfer device 112. The central optical sending fiber 118 is arranged complementary to the central hole 116. The central optical sending fiber 118 and the optical receiving fibers 120 are arranged such that they have an identical optical axis, see e.g. the embodiment shown in FIG. 1, or a coaxial baseline, see e.g. the embodiment shown in FIG. 2.

The transfer device 112 may be adapted to guide the light beam onto the optical receiving fibers 120. The transfer device 112 may be configured for collimating the received light. The transfer device 112 may comprise at least one lens or system of lenses. The transfer device 112 may function as a coupling element configured for coupling the light beam travelling from the object to the measurement head 110 into the optical receiving fibers 120. Therefore the transfer device 112 may be arranged in direction of propagation of the light beam travelling from the object to the measurement head 112 in front of the optical receiving fibers 120.

The transfer device 112 may have an optical axis 122. In particular, the measurement head 110 and the transfer device 112 have a common optical axis 122. The optical axis 122 of the measurement head 110 may be a line of symmetry of the optical setup of the measurement head 110. The transfer device 112 may constitute a coordinate system, wherein a longitudinal coordinate is a coordinate along the optical axis 122 and a transversal coordinate is a coordinate perpendicular thereto. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The transfer device 112 comprises the central hole 116. The central hole 116 may be a through hole from a first surface of the transfer device 112 to an opposing second surface of the transfer device 112. The central hole 116 may be a three dimensional recess and/or cutout and/or interruption of the transfer device 112. The central hole 116 may be arranged at a center of symmetry and/or a center of gravity of a surface of the transfer device 112. The center may be on the optical axis 122 of the transfer device 112.

The optical receiving fiber 120 may be configured for receiving and/or collecting the light beam travelling from the object to the measurement head 110. Specifically, each of the optical receiving fibers 120 may be and/or may comprise at least one optical measurement fiber. The optical measurement fiber may be at least one angle dependent optical element having at least one optical fiber configured to provide an incoming light beam to at least one optical sensor. The optical receiving fiber 120 may comprise two ends. The optical receiving fiber 120 may comprise at least one receiving end adapted to receive at least one light beam originating from the object. The optical receiving fiber 120 may comprise at least one exit-end from which the light beam originating from the object leaves the optical receiving fiber 120. The receiving end may also be denoted as at least one entrance face of the at least one receiving fiber 120 which may also be denoted as the position where the light beam travelling from the object to the measurement head impinges on the optical receiving fiber. Without wishing to be bound by this theory, it is believed that the angle of incidence of a light beam received by the optical receiving fiber 120 is preserved such that the angle of incidence is equal to the exit-angle, assuming that the angle of incidence is equal or smaller than the acceptance angle of the optical receiving fiber. Thus, distance information encoded in the light beam can be essentially preserved and can be evaluated using a combined signal Q, which will be described in detail below.

The optical receiving fibers 120 may be arranged in a direction of propagation of the incident light beam propagating from the object to the measurement head 110 behind the transfer device 112. The optical receiving fibers 120 and the transfer device 112 may be arranged such that the light beam propagating from the object to the measurement head 110 passes through the transfer device 112 before impinging on the optical receiving fibers 120.

With respect to design and embodiments of the optical receiving fibers reference is made to WO 2020/039084, the full content of which is herewith included by reference.

Each of the optical receiving fibers 120 may be configured to generate the at least one light beam having at least one beam profile depending on the angle of incidence of the incident light beam propagating from the object towards the measurement head 110 and impinging on the respective optical receiving fiber 120. In particular, each of the optical receiving fibers 120 may be adapted to influence and/or change and/or adjust the beam profile of the incident light beam. For example, each of the optical receiving fibers 120 may have one or more of angle dependent transmission properties, angle dependent reflection properties or angle dependent absorption properties. The light beam having passed through the respective optical receiving fiber 120 may comprise at least one transmission light beam and/or at least one reflection light beam. The angle of incidence may be measured with respect to an optical axis of the optical receiving fiber 120 such as of the entrance face.

The measurement head 110 may further comprise an illumination source, not shown here, for illuminating the object. The illumination source may be configured for illuminating the object, for example, by directing a light beam towards the object, which reflects the light beam. The illumination source may be configured for generating an illuminating light beam for illuminating the object. Therefore, the illumination source may comprise at least one light source. Specifically, the illumination source may comprise at least one laser and/or laser source. The light source may be or may comprise at least one multiple beam light source. For example, the light source may comprise at least one laser source and one or more diffractive optical elements (DOEs). The illumination source may be adapted to illuminate the object through at least one angle-dependent optical element. Various types of lasers may be employed, such as semiconductor lasers. Additionally or alternatively, non-laser light sources may be used, such as LEDs and/or light bulbs. The illumination source may be adapted to generate and/or to project a cloud of points, for example the illumination source may comprise one or more of at least one digital light processing projector, at least one LCoS projector, at least one spatial light modulator; at least one diffractive optical element; at least one array of light emitting diodes; at least one array of laser light sources. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300 to 1000 nm, especially 500 to 1000 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1000 nm may be used. On account of their generally defined beam profiles and other properties of handleability, the use of at least one laser source as the illumination source is particularly preferred.

The bundle of optical fibers comprises the at least one central optical sending fiber 118. The central optical sending fiber 118 may be configured for sending a light beam to the object. The central optical sending fiber 118 may be arranged at center of symmetry and/or a center of gravity of a surface of the transfer device 112. The center may be on the optical axis 122 of the transfer device 112.

The central optical sending fiber 118 may be connectable with the at least one illumination source. The central optical sending fiber 118 may have at least one entrance end. The at least one light source may be positioned at the entrance end. The illumination source may comprise at least one coupling element configured to couple at least one light beam generated by the light source into the central optical sending fiber 118. The central optical sending fiber 118 may further comprise at least one exit end, wherein the exit end is configured to emit the light beam having passed through the central optical sending fiber 118.

The plurality of optical receiving fibers 120 is arranged radially symmetric around the central optical sending fiber 118. The optical receiving fibers 120 may be arranged in at least one circle around the central optical sending fiber 118, wherein opposing optical receiving fibers 120 may have identical distance to the central optical sending fiber 118. For example, the optical receiving fibers 120 may be arranged concentrically around the central optical sending fiber 118. Each optical receiving fiber 120 may have the at least one entrance face. A geometric center of the respective entrance face may be aligned perpendicular with respect to the optical axis 122 of the transfer device 112. A geometric center of the respective entrance face may be aligned parallel to the exit face of the central optical sending fiber 118. The optical receiving fibers 120 may have identical core diameters. The optical receiving fibers 120 may have different core diameters. The measurement head 110 may comprise first optical receiving fibers 124 having smaller core diameter arranged radially symmetric around the central optical sending fiber 118 and second optical receiving fibers 126 having greater core diameter arranged radially symmetric around the central optical sending fiber. The first optical receiving fibers 124 may be configured for sampling an inner part of an image of the object, wherein the second optical receiving fibers 126 may be configured for sample the whole image of the object. Since an image of the object received by optical receiving fibers 120 is also annular, the part of the image with the highest intensity may not be lost. By dividing the signals from one of the first and one of the second optical fibers 124, 126, a combined signal can be calculated and the distance can be determined.

The central optical sending fiber 118 is arranged complementary to the central hole 116. The central optical sending fiber 118 may be arranged directly or indirectly within and/or through the central hole 116. The exit face of the central optical sending fiber 118 may have the same or different diameter than a diameter of the central hole 116. For example, the central optical sending fiber 118 may be fed through the central hole 116. For example, the central optical sending fiber 118 may be connected with a GRIN lens arranged within the central hole 116 of the transfer device. In known measurement heads with a full lens, the reflection of the illumination light at the back surface of the lens may lead to an offset and falsify the measurement. A hole in the middle of the lens may allow to solves this problem. The central optical sending fiber 118 may be fed through the transfer device, to avoid back-reflections. Optionally, the central optical sending fiber 118 can be connected with a GRIN Lens, which goes through the hole. In both cases, the reflection at the back end may be prevented.

The central optical sending fiber 118 and the optical receiving fibers 120 are arranged such that they have an identical optical axis 122. Specifically, the measurement head 110 may have no baseline. In particular, the baseline may be a distance between at least one illumination channel and at least one receiver channel. Specifically, a distance, for example in a xy-plane, between at least one illumination channel and at least one receiver channel may be as small as possible. Specifically, the baseline may be a distance between the position where the light beam propagating from the object to the measurement head 110 impinges on the optical receiving fibers 120, in particular at least one entrance face or end of the at least one optical receiving fiber 120, and the exit face of the central optical sending fiber 118.

For example, the transfer device 112 may be a radially symmetric lens. The transfer device 112 having a symmetry in which the transfer device is invariant to all rotations, in particular around all axes through a center of symmetry. The radially symmetric lens may be a spherical or an aspherical lens. The central optical sending fiber may be fed through the central hole. In particular, in FIG. 1, an aspherical lens with central hole 116 is shown. Specifically, the measurement head 110 may comprise a single standard lens in front of the coaxial bundle of optical fibers, where the light is sent through the central optical sending fiber 118 and received by the optical receiving fibers 120. In this case, the central optical sending fiber 118 and the optical receiving fibers 120 will have the same optical axis 120, and on axis measurement can be achieved.

In FIG. 2, the central optical sending fiber 118 and the optical receiving fibers 120 are arranged such that they have a coaxial baseline. For example, the transfer device 112 may be an annular axial lens, for example a lens having a torus form. The annular axial lens may be a spherical or aspherical lens. The annular axial lens may allow preventing that the photons accepted by the lens may be mainly focused to the central optical sending fiber 118, where some of the photons are absorbed or reflected without hitting the optical receiving fibers 120, and that the central part, which yields the highest intensity is lost. Both effects would lead to a strong radiant power loss. The annular axial lens may be more efficient in feeding the received light to the optical receiving fibers 120. The curvature of the lens can be spherical or aspherical, depending on the application. In this embodiment, the optical axes of the central optical sending fiber and the optical receiving fibers 120 may be separated by a coaxial baseline. However, the “baseline” between the central optical sending fiber 118 and optical receiving fibers 120 may not be linear, but radial. This may allow a coaxial, on axis measurement. The optical receiving fibers 120 may be arranged in a blur range of the annular axial lens, in particular a radial symmetric lens, such that it may be possible to determine a blurred image. Such a design, in particular lens design, may allow measurements using information from beam profile analysis as described herein.

Beam profile analysis may allow distance measurements without a baseline. Alike ToF, the baseline may not be needed for the measurement itself. However, due to manufacturing restrictions, it typically difficult to position the light source and the detector coaxially. Such a coaxial setup can be realized by using the optical fiber bundle according to the present invention. Such an arrangement cannot be used for ToF measurements, since multi-mode fibers significantly deteriorate the measurement. However, for beam profile analysis using of such a setup may be advantageous. The radially symmetric measurement head 110 may allow eliminating occlusion errors. Errors arising due to non-flat target surfaces can be compensated to a certain level. The pepita effect can be eliminated, as long as the beam spot is in the middle of the non-uniform target.

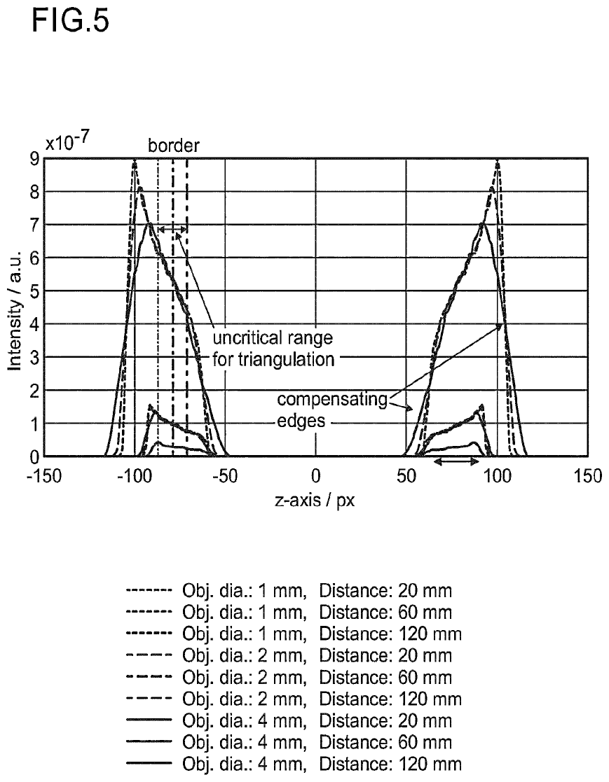

FIGS. 4A and 4B show embodiments of measurement heads 110 in a cross section. Radially symmetric measurement heads 110 are shown. FIG. 4A shows an implementation of the radially symmetric measurement head 110 with different core diameters of the optical receiving fibers, in particular of first optical receiving fibers 124 and second optical receiving fibers 126. A metallic cylinder 128 is shown having a constant radius from the central optical sending fiber 118 in its center is show. The first optical receiving fibers 124 and second optical receiving fibers 126 may be arranged alternatingly on a jacket of the cylinder 128. The cores with the smaller diameter, which constitute the optical receiving fiber 124, sample the inner part of the image, while the larger cores of optical receiving fiber 126 sample the whole image (inner and outer). By dividing the signals from both fibers, the combined signer can be calculated. FIG. 4B shows an embodiment of the radially symmetric measurement head 110 with different core diameters of the optical receiving fibers, in particular of first optical receiving fibers 124 and second optical receiving fibers 126, too. Specifically, FIG. 4B shows a possible assembly of optical fibers to sample the different parts of the compensating edges. A border between the first optical receiving fibers 124 and the second optical receiving fibers 126 is shown. For example, the transfer device may have an outer diameter of 5 mm. For example, the diameter of the first optical receiving fibers 124 0.25 and the second optical receiving fiber may be 0.5 mm. FIG. 5 shows the normalized combined signal Q calculated for the assembly of FIG. 4B as a function of target distance (“distance” in mm) for different object sizes. As one can see, the proposed implementation of a measurement head 110 according to the present invention not only ensures the radial symmetry but also the object size independency.

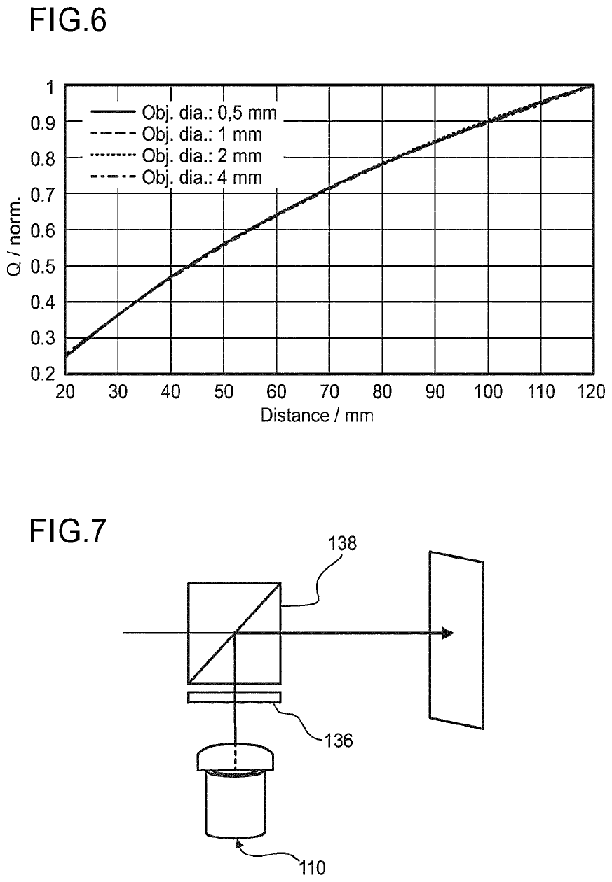

A very characteristic feature of the beam profile analysis is the object size independency. Object size independence was tested with the following test setup. An annular axial lens was simulated with the CAE-software Zemax. The lens has an outer diameter of 5 mm and an inner diameter of 0.7 mm. The focal length of the lens yields 1.367 and its numerical aperture (NA) is 0.609. FIG. 6 presents the radial intensity distribution (“intensity” in a.u.) of the image for different object sizes at different distances (“distance” in z-axis in pixel px) with the above-mentioned lens. The slope of the flanks of circle of confusion changes with varying object size. This change can be compensated by sampling different parts of the slope and calculating a ratio. Thus, the flanks in FIG. 6 are marked as the compensating edges. Even though the baseline is small, the disparity is still recognizable by the movement of the intensity maximum for each distance. The range, where the border can be positioned is thereby reduced. The uncritical range, where the effects of the triangulation can be neglected is also marked in the FIG. 6.

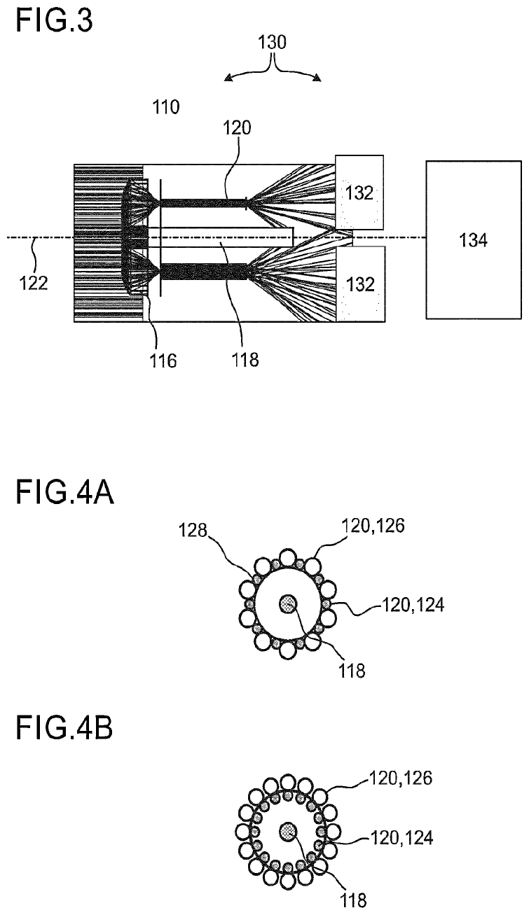

FIG. 3 shows an embodiment of a kit 130 for determining a position of at least one object is disclosed. The kit 130 comprises the measurement head 110 according to the embodiments disclosed above and/or according to one or more of the embodiments disclosed in further detail below. The kit further comprises at least one detector comprising
a plurality of optical sensors 132, wherein each optical sensor 132 has at least one light sensitive area, wherein each optical sensor 132 is designed to generate at least one sensor signal in response to an illumination of its respective light-sensitive area by a light beam having passed through at least one of the optical receiving fibers 120 of the measurement head 110;
at least one evaluation device 134 being configured for determining at least one longitudinal coordinate z of the object by evaluating a combined signal Q from the sensor signals.

The optical sensor 132, each, specifically may be or may comprise at least one photodetector, preferably inorganic photodetectors, more preferably inorganic semiconductor photodetectors, most preferably silicon photodetectors. Specifically, the optical sensor 132 may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor 132 may be or may comprise at least one inorganic photodiode which are sensitive in the infrared spectral range, preferably in the range of 700 nm to 3.0 micrometers. Specifically, the optical sensor 132 may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor 132 may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor 132 may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor 132 may comprise at least one photoconductive sensor such as a PbS or PbSe sensor, a bolometer, preferably a bolometer selected from the group consisting of a VO bolometer and an amorphous Si bolometer.

The optical sensors 132 may be sensitive in one or more of the ultraviolet, the visible or the infrared spectral range. Specifically, the optical sensors 132 may be sensitive in the visible spectral range from 500 nm to 780 nm, most preferably at 650 nm to 750 nm or at 690 nm to 700 nm. Specifically, the optical sensors may be sensitive in the near infrared region. Specifically, the optical sensors 132 may be sensitive in the part of the near infrared region where silicon photodiodes are applicable specifically in the range of 700 nm to 1000 nm. The optical sensors 132, specifically, may be sensitive in the infrared spectral range, specifically in the range of 780 nm to 3.0 micrometers. For example, the optical sensors 132 each, independently, may be or may comprise at least one element selected from the group consisting of a photodiode, a photocell, a photoconductor, a phototransistor or any combination thereof. For example, the optical sensors 132 may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, as will be outlined in further detail below, one or more photodiodes may be used, such as commercially available photodiodes, e.g. inorganic semiconductor photodiodes.

The evaluation device 134 may be adapted to perform the named operations, preferably by using at least one data processing device and, more preferably, by using at least one processor and/or at least one application-specific integrated circuit. Thus, as an example, the at least one evaluation device 134 may comprise at least one data processing device having a software code stored thereon comprising a number of computer commands. The evaluation device 134 may provide one or more hardware elements for performing one or more of the named operations and/or may provide one or more processors with software running thereon for performing one or more of the named operations. Thus, as an example, the evaluation device 134 may comprise one or more programmable devices such as one or more computers, application-specific integrated circuits (ASICs), Digital Signal Processors (DSPs), or Field Programmable Gate Arrays (FPGAs) which are configured to perform the above-mentioned controlling. Additionally or alternatively, however, the evaluation device 134 may also fully or partially be embodied by hardware.

The light beam, in particular the image of the object, received by the optical receiving fibers 120 may comprise a beam profile. The beam profile may be at least one intensity distribution, such as of a light spot on the optical sensor 132, as a function of the pixel. The beam profile may be selected from the group consisting of a trapezoid beam profile; a triangle beam profile; a conical beam profile and a linear combination of Gaussian beam profiles.

The evaluation device 134 is configured for determining at least one longitudinal coordinate z of the object by evaluating a combined signal Q of the sensor signals. Determining the longitudinal coordinate z by using a combined signal Q of the sensor signals is called beam profile analysis or depth-from-photon-ratio (DPR) technique. With respect to determining the longitudinal coordinate z by using a combined signal Q of the sensor signals reference is made to WO 2018/091649 A1, WO 2018/091638 A1 and WO 2018/091640 A1, the full content of which is included by reference.

The evaluation device 134 is configured for determining at least one longitudinal coordinate z of the object by evaluating a combined signal Q from the sensor signals. The combined signal Q may be generated by combining the sensor signals, in particular by one or more of dividing the sensor signals, dividing multiples of the sensor signals or dividing linear combinations of the sensor signals. In particular, the combined signal may be a quotient signal. The combined signal Q may be determined by using various means. As an example, a software means for deriving the combined signal, a hardware means for deriving the combined signal, or both, may be used and may be implemented in the evaluation device. Thus, the evaluation device 134, as an example, may comprise at least one divider, wherein the divider is configured for deriving the quotient signal. The divider may fully or partially be embodied as one or both of a software divider or a hardware divider.

For example, the optical receiving fibers 120 may be arranged to form a radially symmetric measurement head 110. The optical receiving fibers 120 may have different core diameters, e.g. first optical receiving fibers 124 having a smaller core diameter and second optical receiving fibers 126 having a larger core diameter. The cores with the smaller diameter, which constitute the first optical receiving fibers 124, may sample a central part of the image, i.e. the beam profile. The larger cores of the second optical receiving fibers 126 may sample the whole image, i.e. central and edge regions of the beam profile. The evaluation device 134 may be configured for determining the combined signal by dividing the signals from both first and second optical receiving fibers 124, 126.

The evaluation device 134 may be configured for using at least one predetermined relationship between the combined signal Q and the longitudinal coordinate for determining the longitudinal coordinate. The predetermined relationship may be one or more of an empiric relationship, a semi-empiric relationship and an analytically derived relationship. The evaluation device 134 may comprise at least one data storage device for storing the predetermined relationship, such as a lookup list or a lookup table.

FIG. 7 shows a schematic drawing of an embodiment of a laser drilling machine using the measurement head 110 with on-axis distance measurement. The laser drilling machine may be a CO₂-laser drilling machine using at least one CO₂-Laser, e.g. at 10.6 μm. A measurement laser, such as of 633 nm, may be used as illumination source. The laser drilling machine may comprise a band pass filter 136, e.g. at 633 nm, and a beam combiner 138.

### LIST OF REFERENCE NUMBERS

110 measurement head
112 transfer device
114 incident light beam
116 central hole
118 central optical sending fiber
120 optical receiving fiber
122 optical axis
124 first optical receiving fiber
126 second optical receiving fiber
128 metallic cylinder
130 kit
132 optical sensor
134 evaluation device
136 band pass filter
138 beam combiner

1. A measurement head for determining a position of at least one object comprising:
at least one transfer device, wherein the transfer device has at least one focal length in response to the at least one incident light beam propagating from the object to the measurement head, wherein the transfer device comprises a central hole;
at least one bundle of optical fibers, wherein the bundle of optical fibers comprises at least one central optical sending fiber and a plurality of optical receiving fibers arranged radially symmetric around the central optical sending fiber, wherein the central optical sending fiber is configured for sending a light beam for illuminating the object, wherein the optical receiving fibers are configured for receiving the at least one incident light beam propagating from the object to the measurement head having passed the transfer device, wherein the central optical sending fiber is arranged complementary to the central hole, wherein the central optical sending fiber and the optical receiving fibers are arranged such that they have an identical optical axis or a coaxial baseline, wherein the central optical sending fiber is fed through the central hole.

2. The measurement head according to claim 1, wherein the central optical sending fiber is connected with a GRIN lens arranged within the central hole of the transfer device.

3. The measurement head according to claim 1, wherein the central optical sending fiber is connectable with at least one illumination source.

4. The measurement head according to claim 1, wherein the transfer device is a radially symmetric lens, wherein the radially symmetric lens is a spherical or an aspherical lens.

5. The measurement head according to claim 1, wherein the transfer device is an annular axial lens, wherein the annular axial lens is a spherical or aspherical lens.

6. The measurement head according to claim 5, wherein the optical axes of the central optical sending fiber and the optical receiving fibers are separated by a coaxial baseline.

7. The measurement head according to claim 1, wherein the optical receiving fibers have different core diameters.

8. The measurement head according to claim 7, wherein the measurement head comprises first optical receiving fibers having smaller core diameter arranged radially symmetric around the central optical sending fiber and second optical receiving fibers having greater core diameter arranged radially symmetric around the central optical sending fiber, wherein the first optical receiving fibers are configured for sampling an inner part of an image of the object, wherein the second optical receiving fibers are configured for sample the whole image of the object.

9. The measurement head according to claim 1, wherein each optical receiving fiber has at least one entrance face, wherein a geometric center of the respective entrance face is aligned perpendicular with respect to an optical axis of the transfer device.

10. A kit comprising at least one measurement head according to claim 1 and a detector for determining a position of at least one object, the detector comprising:
a plurality of optical sensors, wherein each optical sensor has at least one light sensitive area, wherein each optical sensor is designed to generate at least one sensor signal in response to an illumination of its respective light-sensitive area by a light beam having passed through at least one of the optical receiving fibers of the measurement head;
at least one evaluation device being configured for determining at least one longitudinal coordinate z of the object by evaluating a combined signal Q from the sensor signals.

11. The kit according to claim 1, wherein the evaluation device is configured for deriving the combined signal Q by one or more of dividing the sensor signals, dividing multiples of the sensor signals, and dividing linear combinations of the sensor signals.

12. The kit according to claim 11, wherein the evaluation device is configured for using at least one predetermined relationship between the combined signal Q and the longitudinal coordinate for determining the longitudinal coordinate.

13. A method of using the measurement head according to claim 1, the method comprising using the measurement head for a purpose of use selected from the group consisting of a position measurement in traffic technology; an entertainment application; an optical data storage application; a security application; a surveillance application; a safety application; a human-machine interface application; a logistics application; an endoscopy application; a medical application; a tracking application; a photography application; a machine vision application; a robotics application; a quality control application; a 3D printing application; an augmented reality application; a manufacturing application; optical data storage and readout; a rotational scanner; a laser drilling machine, and combinations thereof.
